(19) United States
(12) Patent Application Publication
(10) Pub. No.: US 2015/0212273 A1
(43) Pub. Date: Jul. 30, 2015

(54) OPTICAL FIBER ADAPTER WITH EMBEDDED OPTICAL ATTENUATOR

(71) Applicant: Adtran, Inc., Huntsville, AL (US)

(72) Inventors: Leif J. Sandstrom, Huntsville, AL (US); Michael J. Tempel, Marietta, GA (US)

(21) Appl. No.: 14/494,632

(22) Filed: Sep. 24, 2014

Related U.S. Application Data
(60) Provisional application No. 61/933,532, filed on Jan. 30, 2014.

(51) Int. Cl. G02B 6/26; G02B 6/10; G02B 6/34

(52) U.S. Cl. CPC G02B 6/266; G02B 6/34; G02B 6/105

(57) ABSTRACT

A device includes an optical fiber adapter configured to releasably connect a first optical fiber and a second optical fiber, the optical fiber adapter configured to lenselessly couple an optical signal from the first optical fiber to the second optical fiber and an optical attenuator embedded in the optical fiber adapter, the optical attenuator configured to variably attenuate the optical signal responsive to a control signal.

### RELATED APPLICATION

The present application claims priority to and the benefit of the filing date of U.S. Provisional Application No. 61/933,532, entitled “Optical Fiber Adapter With Embedded Optical Attenuator” (Attorney Docket No. 01070.0018U1) filed on Jan. 30, 2014, the entirety of which is incorporated into this document by reference.

### BACKGROUND

In optical communication systems, it is desirable to both connect optical fibers together, and to regulate the power and spectra of the optical signals carried in the optical fibers. Connectorized fiber optic segments are typically mated using an optical fiber adapter. The optical fiber adapter is constructed to provide a reliable mechanical connection between the connectorized fiber optic segments, and to precisely align the respective segments so that optical signals can be transferred between the fiber optic segments with minimal signal loss.

Regulating the power of optical signals includes completely attenuating or blocking the optical signal, and partially attenuating the optical signal. Attenuation of the optical signal includes removing some of the power of the optical signal from the optical channel while leaving the spectrum of the optical signal intact; and attenuating only certain spectral components of the optical signal and leaving other spectral components of the optical signal unmodified.

Currently, there are optical fiber adapters that can couple or adapt one fiber optic segment to another, and optical fiber adapters that can also simultaneously provide a fixed, or manually variable amount of signal attenuation. However, an optical fiber adapter that can provide a user specified amount of signal attenuation based on electronic control signals is not available.

### SUMMARY

Embodiments of a device include an optical fiber adapter configured to releasably connect a first optical fiber and a second optical fiber, the optical fiber adapter configured to lenselessly couple an optical signal from the first optical fiber to the second optical fiber and an optical attenuator embedded in the optical fiber adapter, the optical attenuator configured to variably attenuate the optical signal responsive to a control signal.

Other embodiments are also provided. Other systems, methods, features, and advantages of the invention will be or become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE FIGURES

Exemplary embodiments of the invention can be better understood with reference to the following figures. The components within the figures are not necessarily to scale, emphasis instead being placed upon clearly illustrating the principles of the invention. Moreover, in the figures, like reference numerals designate corresponding parts throughout the different views.

FIG. 1 shows a diagram of a communication system in which an optical fiber adapter with embedded optical attenuator may be implemented.

FIG. 2 shows a diagram of an embodiment of an optical fiber adapter with embedded optical attenuator.

FIG. 3A shows an exemplary embodiment of the optical attenuator of FIG. 2 in a first configuration.

FIG. 3B shows an exemplary embodiment of the optical attenuator of FIG. 3A in a second configuration.

FIG. 4A shows an alternative exemplary embodiment of the optical attenuator of FIG. 2 in a first configuration.

FIG. 4B shows an exemplary embodiment of the optical attenuator of FIG. 4A in a second configuration.

FIG. 5A shows an alternative exemplary embodiment of the optical attenuator of FIG. 2 in a first configuration.

FIG. 5B shows an exemplary embodiment of the optical attenuator of FIG. 5A in a second configuration.

FIG. 6A shows an alternative exemplary embodiment of the optical attenuator of FIG. 2 in a first configuration.

FIG. 6B shows an exemplary embodiment of the optical attenuator of FIG. 6A in a second configuration.

FIG. 7A shows an alternative exemplary embodiment of the optical attenuator of FIG. 2 in a first configuration.

FIG. 7B shows an exemplary embodiment of the optical attenuator of FIG. 7A in a second configuration.

FIG. 8A shows an alternative exemplary embodiment of the optical attenuator of FIG. 2 in a first configuration.

FIG. 8B shows an exemplary embodiment of the optical attenuator of FIG. 8A in a second configuration.

FIG. 9 shows an alternative exemplary embodiment of the optical fiber adapter with embedded optical attenuator of FIG. 2.

FIG. 10 is a flow chart describing an exemplary embodiment of a method for optical attenuation.

### DETAILED DESCRIPTION

There are many instances where it would be desirable to have an optical fiber adapter that also can provide automated, user specified control of the power and spectra of the optical signals carried in the optical fibers. Exemplary embodiments of an optical fiber adapter with embedded optical attenuator can connect fiber optic segments and can provide electrically controlled levels of optical attenuation to an optical signal traversing the fiber optic segments and the optical fiber adapter. In an exemplary embodiment, the attenuator can completely attenuate or prevent coupling of the optical signal between the fibers, or in other exemplary embodiments, the attenuator can partially attenuate the optical signal. In an exemplary embodiment, attenuating the optical signal may comprise completely or partially blocking the optical signal so as to reduce or eliminate the ability of the optical signal to transfer communication information. In other exemplary embodiments, attenuating the optical signal may comprise using diffraction or refraction to disperse or divert the optical signal and thereby prevent optical signal coupling from one optical fiber to another optical fiber. In these embodiments that use diffraction or refraction, the optical signal passes through the optical fiber adapter with embedded optical attenuator without being blocked, but the optical signal is not coupled from one optical fiber to another optical fiber.

In an exemplary embodiment, the optical fiber adapter with embedded optical attenuator can be located so as to completely attenuate the optical signals to and/or from an unauthorized or malfunctioning optical device. Embodiments of the optical fiber adapter with embedded optical attenuator can also be used for planned service interruptions independent of the equipment at the network termination points.

The optical fiber adapter with embedded optical attenuator can be used in any application where it is desirable to connect two or more optical fibers and to regulate the power of the optical signals carried by the optical fibers. For example, on a network with multiple transceivers, such a power balancing function can be used to improve network performance by partially attenuating high power signals such that received signal powers are approximately equal. In other exemplary embodiment, the optical fiber adapter with embedded optical attenuator can be used to block an optical signal traveling to or from an optical communication device located in an optical communication network. For example, the optical fiber adapter with embedded optical attenuator can be used to block an optical signal emanating from an unauthorized or malfunctioning (also referred to as “rogue”) optical communication device.

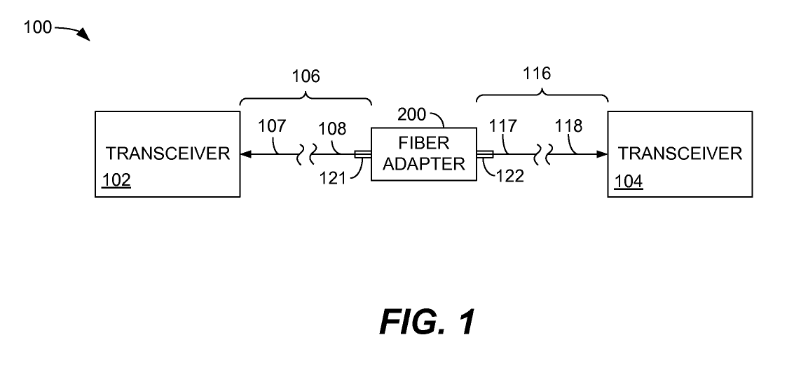

FIG. 1 shows a diagram of a communication system in which an optical fiber adapter with embedded optical attenuator may be implemented. The system 100 comprises a transceiver 102 and a transceiver 104 connected to each other using optical fibers 106 and 116. The optical fiber 106 comprises optical fiber segments 107 and 108, and the optical fiber 116 comprises optical fiber segments 117 and 118. Although illustrated for simplicity as including two optical fiber segments each, the optical fibers 106 and 116 can include more or fewer optical fiber segments, and are illustrated as having multiple optical fiber segments to illustrate that the optical fiber network connecting two or more transceivers is typically made up of many different optical fiber segments and connections.

In an exemplary embodiment, the optical fiber segments 108 and 117 are connected to an optical fiber adapter 200 through respective optical connectors 121 and 122. The optical fiber adapter 200 and the connectors 121 and 122 may comply with an industry standard connection form factor such as, for example only, duplex LC, SC, or another industry standard connection form factor, to provide precise alignment between the mated optical fiber segments 108 and 117 within the optical fiber adapter 200. In an exemplary embodiment, the optical fiber adapter 200 includes an embedded optical attenuator in accordance with exemplary embodiments of the optical fiber adapter with embedded optical attenuator described herein.

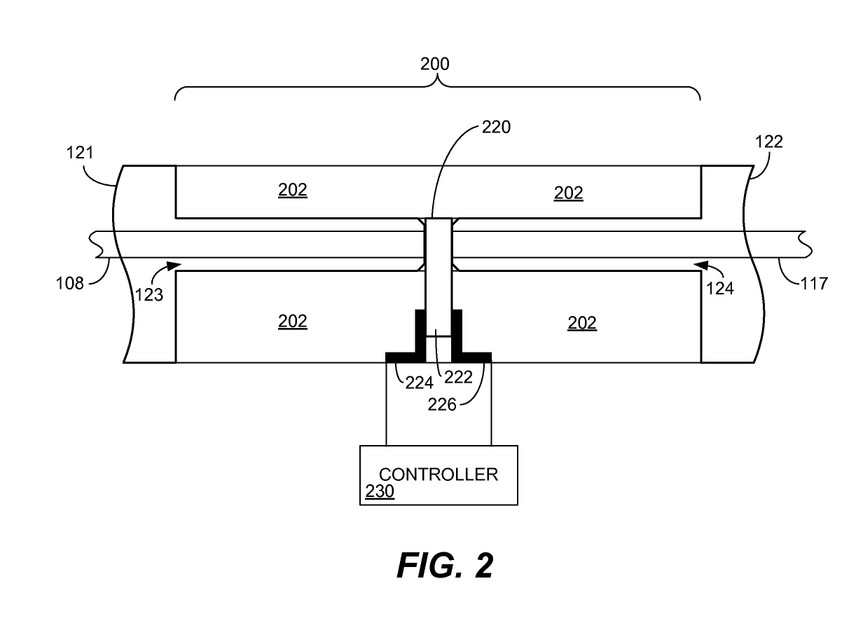

FIG. 2 shows a diagram of an embodiment of an optical fiber adapter with embedded optical attenuator. The optical fiber adapter 200 comprises a body 202 into which connectors 121 and 122 may be releasably mated. In an example, the connector 121 includes a ferrule 123 that properly supports and aligns the optical fiber segment 108 within the body 202. The other components of the connector 121 are not shown for simplicity of illustration. Similarly, the connector 122 includes a ferrule 124 that properly supports and aligns the optical fiber segment 117 within the body 202. The other components of the connector 122 are not shown for simplicity of illustration.

The optical fiber adapter 200 also comprises an optical attenuator 220. The optical attenuator 220 comprises a body 222 and electrical contacts 224 and 226. The optical fiber adapter 200 may also comprise optional lenses, which in some exemplary embodiments aid in the coupling of optical signals between the optical fiber segment 108 and the optical fiber segment 117 through the optical attenuator 220. Although FIG. 2 shows the optical attenuator 220 as being vertically integrated in the optical fiber adapter 200, and being substantially orthogonal to the optical fiber segment 117 and the optical fiber segment 108, the optical fiber adapter with embedded optical attenuator is not so limited. For example, the optical fiber adapter with embedded optical attenuator can be implemented in a system that uses SC/APC connectors, which have an end-face that is beveled at approximately 8 degrees and where the SC/APC adapter is keyed so the respective connector faces meet at the substantially 8 degree bevel. Consequently, in an optical fiber adapter having an embedded attenuator intended for use with an SC/APC connector interface, the attenuator would be offset from vertical by approximately 8 degrees. In an exemplary embodiment, the optical fiber adapter 200 allows an optical signal to be lenselessly coupled directly from the optical fiber segment 108, through the optical attenuator 220 to the optical fiber segment 117.

In an exemplary embodiment, the body 222 of the optical attenuator 220 comprises optical attenuation means that can partially or completely attenuate the optical signal passing between the optical fiber segment 108 and the optical fiber segment 117 in response to a control signal provided through the electrical contacts 224 and 226. The control signal may be provided by a controller 230. The controller can be any type of control element that can provide a signal to control the operation of the optical attenuator 220. A simple controller may comprise a voltage source or a current source. In another exemplary embodiment, the controller 230 can comprise a management platform for a telecommunications system. Although illustrated as a single element, the controller 230 may also comprise a distributed control system having multiple components. In an exemplary embodiment, the controller may be implemented in software, hardware, or a combination of software and hardware. When implemented in hardware, the controller 230 can be implemented using specialized or generally known hardware elements. When implemented in software, the controller 230 can be implemented using processor-executable code running on a computing device. The software can be stored in a memory and executed by a suitable instruction execution system (microprocessor). The hardware implementation of the controller 230 can include any or a combination of the following technologies, which are all well known in the art: discrete electronic components, a discrete logic circuit(s) having logic gates for implementing logic functions upon data signals, an application specific integrated circuit having appropriate logic gates, a programmable gate array(s) (PGA), a field programmable gate array (FPGA), a separate, specially designed integrated circuit, etc.

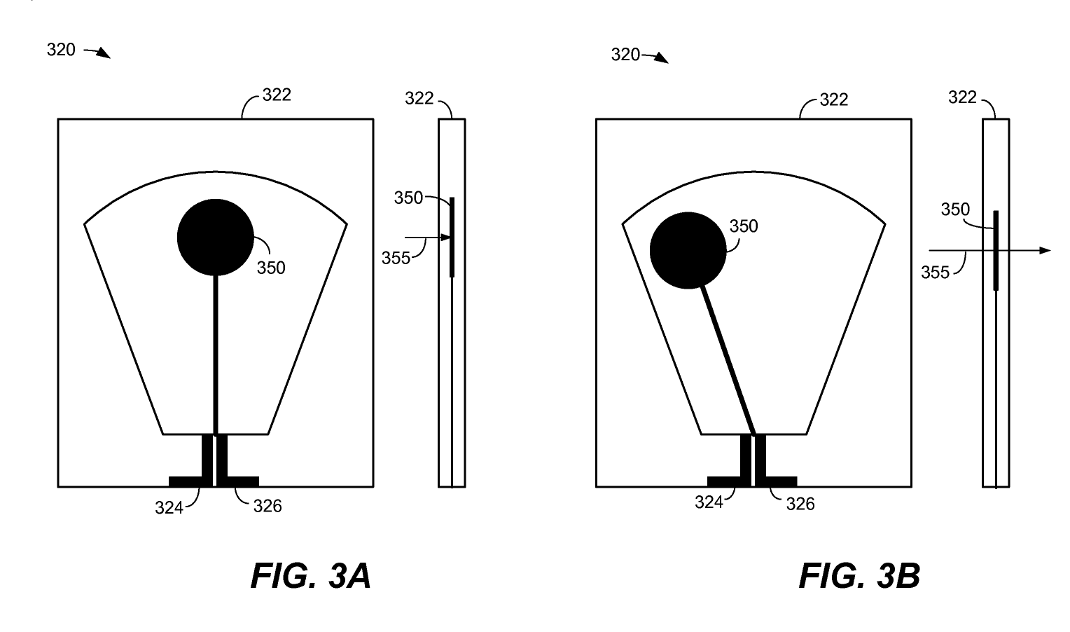

FIG. 3A shows an exemplary embodiment of the optical attenuator of FIG. 2 in a first configuration. The embodiment shown in FIG. 3A is referred to as a “shutter” type attenuator in that it uses mechanical movement of an element to attenuate the optical signal. An optical attenuator 320 comprises a body 322 and electrical contacts 324 and 326. The body 322 comprises a mechanical shutter 350 that can be fabricated using micro-electromechanical system (MEMS) technology. The shutter 350 can be positioned to completely or partially interrupt the optical signal. When oriented as shown in FIG. 3A, the shutter 350 is located in a first position relatively centered within the body 322 such that an optical signal 355, or components thereof, entering the body 322 is attenuated by the presence of the shutter 350 in the optical path.

FIG. 3B shows an exemplary embodiment of the optical attenuator of FIG. 3A in a second configuration. When oriented as shown in FIG. 3B, the shutter 350 is located in a second position located toward a side of the body 322 and away from the optical path such that an optical signal 355 entering the body 322 is not attenuated and traverses the optical attenuator 320 unimpeded. In an exemplary embodiment, the position of the shutter 350 can be controlled by a control signal applied through the electrical contacts 324 and 326 to affect the movement of the shutter 350 between the first position and the second position. When oriented between the first and second positions shown in FIG. 3A and FIG. 3B, the shutter 350 can provide partial attenuation of the optical signal 355 traversing the optical attenuator 320.

In another exemplary embodiment, the shutter 350 may be fabricated to incorporate spectral filtering capability into the shutter 350, so as to attenuate some or all of the optical signal's spectrum. In other exemplary embodiments, multiple shutters can be implemented having varying levels of optical signal attenuation capability to allow variable attenuation of an optical signal passing through the body 322.

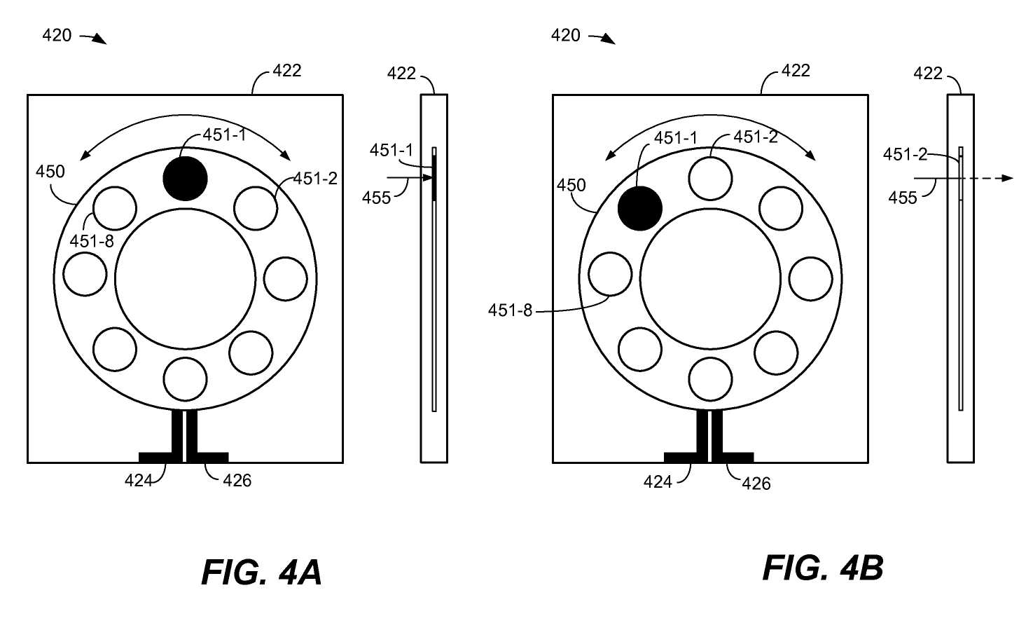

FIG. 4A shows an alternative exemplary embodiment of the optical attenuator of FIG. 2 in a first configuration. The embodiment shown in FIG. 4A is referred to as a “rotating” type attenuator in that it uses mechanical rotation of an element to completely or partially interrupt the optical signal. An optical attenuator 420 comprises a body 422 and electrical contacts 424 and 426. The body 422 comprises a rotating element 450 that can be fabricated using micro-electromechanical system (MEMS) technology. The rotating element 450 comprises a plurality of filters 451-1 through 451-8, in this example, exemplary ones of which are illustrated using reference numerals 451-1 and 451-2. Each filter can be fabricated to completely or partially attenuate the entire spectrum of the optical signal or only specific spectral components of the optical signal. In this exemplary embodiment, the filter 451-1 can be fabricated to completely attenuate the optical signal and the filter 451-2 can be fabricated to partially attenuate the optical signal. In other exemplary embodiments, filters can be fabricated to attenuate an optical signal over a range of optical attenuation values, from zero optical attenuation to complete optical attenuation. When oriented as shown in FIG. 4A, the rotating element 450 is in a first position such that the filter 451-1 is located such that an optical signal 455 entering the body 422 is attenuated by the presence of the filter 451-1 in the optical path.

FIG. 4B shows an alternative exemplary embodiment of the optical attenuator of FIG. 4A in a second configuration. When oriented as shown in FIG. 4B, the rotating element 450 is located in a second position such that the filter 451-2 is located such that an optical signal 455 entering the body 422 is not attenuated, or is partially attenuated and traverses the optical attenuator 420. In an exemplary embodiment, the position of the rotating element 450 can be controlled by a control signal applied through the electrical contacts 424 and 426 to effect the movement of the rotating element 450 through a variety of positions associated with the number of filters on the rotating element 450.

In an exemplary embodiment, the filters could also provide different attenuation values for signals propagating in different directions. For example, the filters could be used to provide independent attenuation levels to optical signals traveling in different directions (e.g., from the connector 121 toward the connector 122 and from the connector 122 toward the connector 121, FIG. 1), provided those signals are at different wavelengths.

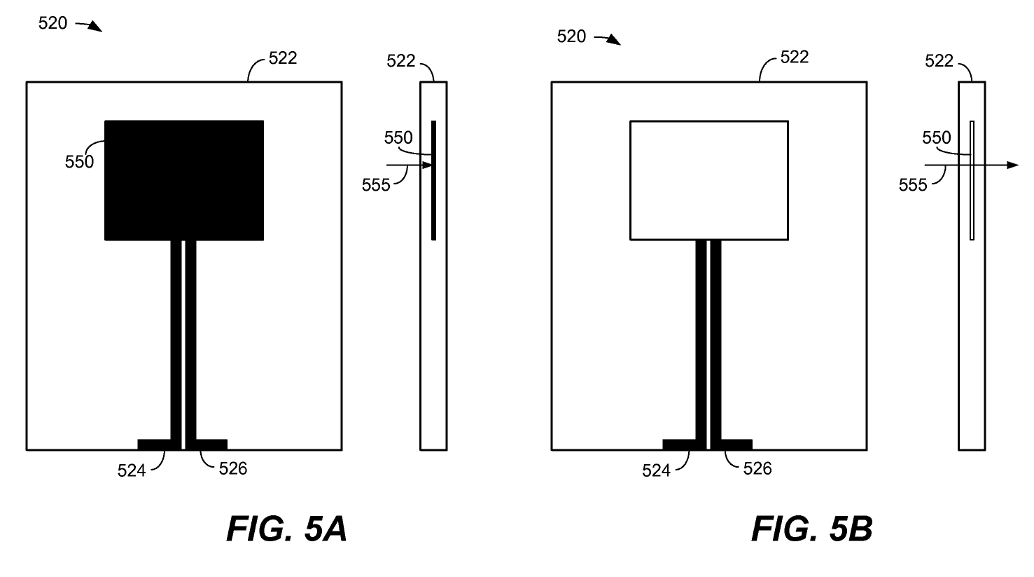

FIG. 5A shows an alternative exemplary embodiment of the optical attenuator of FIG. 2 in a first configuration. The embodiment shown in FIG. 5A is referred to as a “panel” type attenuator in that it uses an element having variable and controllable optical transmissivity. For example, an electro-chromic or electro-optic element can be implemented as an optical attenuator element to completely or partially interrupt the optical signal. An optical attenuator 520 comprises a body 522 and electrical contacts 524 and 526. The body 522 comprises a panel type element 550. In an exemplary embodiment, the panel type element 550 can be controlled to completely or partially attenuate the optical signal. When configured as shown in FIG. 5A, the panel type element 550 is in a first (non-transmissive) state such that an optical signal 555 entering the body 522 is attenuated by the panel type element 550 in the optical path.

FIG. 5B shows an exemplary embodiment of the optical attenuator of FIG. 5A in a second configuration. When oriented as shown in FIG. 5B, the panel type element 550 is in a second state such that an optical signal 555 entering the body 522 is not attenuated, and traverses the optical attenuator 520 unmodified. The attenuation of the panel type element 550 can be controlled by a control signal applied through the electrical contacts 524 and 526 to attenuate an optical signal over a range of attenuation values, effectively from zero, or near zero attenuation to complete, or near complete attenuation.

In an exemplary embodiment, the panel type element 550 could also provide different attenuation values for signals propagating in different directions. For example, element 550 could be used to provide independent attenuation levels to optical signals traveling in different directions (e.g., from the connector 121 toward the connector 122 and from the connector 122 toward the connector 121, FIG. 1), provided those signals are at different wavelengths.

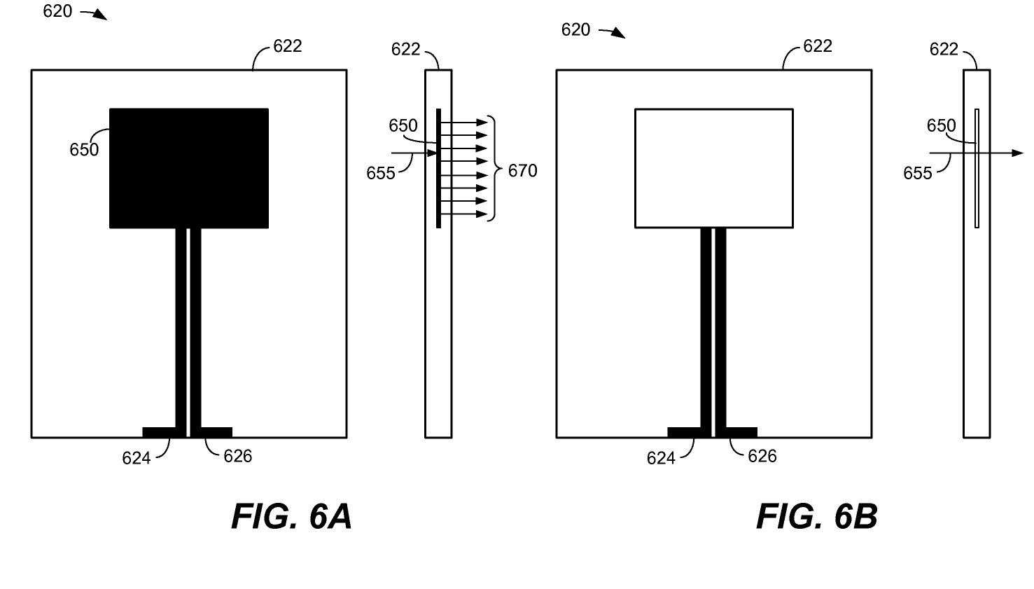

FIG. 6A shows an alternative exemplary embodiment of the optical attenuator of FIG. 2 in a first configuration. The embodiment shown in FIG. 6A is referred to as a “diffractive” type attenuator in that it uses diffraction to disperse the signal and thereby prevent coupling of the optical signal. In this embodiment, the optical signal passes through the attenuator but is not coupled from one fiber to the next.

For example, a diffractive element can be implemented as an optical attenuator element to completely or partially divert, spread or spatially disperse the optical signal and or the optical signal energy. An optical attenuator 620 comprises a body 622 and electrical contacts 624 and 626. The body 622 comprises a diffractive element 650. The diffractive element 650 can be controlled to completely or partially attenuate the optical signal such that although the optical signal may pass through the body 622, the optical signal is prevented from coupling from one optical fiber to another. When configured as shown in FIG. 6A, the diffractive element 650 is in a first state such that an optical signal 655 entering the body 622 is allowed to pass through the body 622, but is affected in such a way that it is prevented from coupling to an optical fiber. For example, the diffractive element 650 may split the optical signal 655 into a number of different light beams 670 having different wavelengths, and thus is prevented from coupling to another optical fiber.

FIG. 6B shows an exemplary embodiment of the optical attenuator of FIG. 6A in a second configuration. When oriented as shown in FIG. 6B, the diffractive element 650 is in a second state such that an optical signal 655 entering the body 622 is allowed to pass through the body 622 and traverse the optical attenuator 620 unmodified. The attenuation of the diffractive element 650 can be controlled by a control signal applied through the electrical contacts 624 and 626 to attenuate an optical signal over a range of attenuation values, effectively from zero, or near zero attenuation to complete, or near complete attenuation.

In an exemplary embodiment, the diffractive element 650 could also provide different attenuation values for signals propagating in different directions. For example, element 650 could be used to provide independent attenuation levels to optical signals traveling in different directions (e.g., from the connector 121 toward the connector 122 and from the connector 122 toward the connector 121, FIG. 1), provided those signals are at different wavelengths.

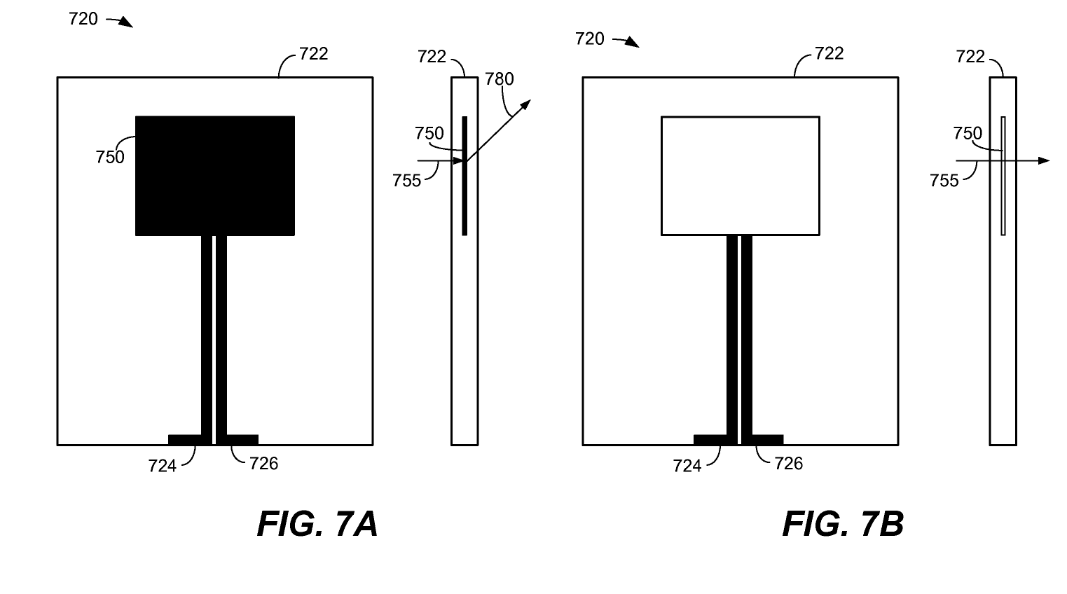

FIG. 7A shows an alternative exemplary embodiment of the optical attenuator of FIG. 2 in a first configuration. The embodiment shown in FIG. 7A is referred to as a “refractive” type attenuator in that it uses a refractive index gradient to bend the light signal and thereby prevent coupling of the optical signal. In this embodiment, the optical signal passes through the attenuator but is not coupled from one fiber to the next.

For example, a refractive element can be implemented as an optical attenuator element to completely or partially redirect the optical signal. An optical attenuator 720 comprises a body 722 and electrical contacts 724 and 726. The body 722 comprises a refractive element 750. The refractive element 750 can be controlled to completely or partially divert the optical signal such that although the optical signal may pass through the body 722, the optical signal is prevented from coupling from one optical fiber to another. When configured as shown in FIG. 7A, the refractive element 750 is in a first state such that an optical signal 755 entering the body 722 is allowed to pass through the body 722, but is affected in such a way that it is prevented from coupling to an optical fiber. For example, the refractive element 750 diverts the optical signal 755 as a result of encountering a different transmission medium, so that the optical signal 755 is refracted resulting in a light beam 780 that is thus prevented from coupling to another optical fiber. Examples of a refractive element include any lens or optical element that can bend or otherwise alter the direction of the optical signal 755.

FIG. 7B shows an exemplary embodiment of the optical attenuator of FIG. 7A in a second configuration. When oriented as shown in FIG. 7B, the refractive element 750 is in a second state such that an optical signal 755 entering the body 722 is allowed to pass through the body 722 and traverse the optical attenuator 720 unmodified. The attenuation of the refractive element 750 can be controlled by a control signal applied through the electrical contacts 724 and 726 to attenuate an optical signal over a range of attenuation values, effectively from zero, or near zero attenuation to complete, or near complete attenuation.

In an exemplary embodiment, the refractive element 750 could also provide different attenuation values for signals propagating in different directions. For example, element 750 could be used to provide independent attenuation levels to optical signals traveling in different directions (e.g., from the connector 121 toward the connector 122 and from the connector 122 toward the connector 121, FIG. 1), provided those signals are at different wavelengths.

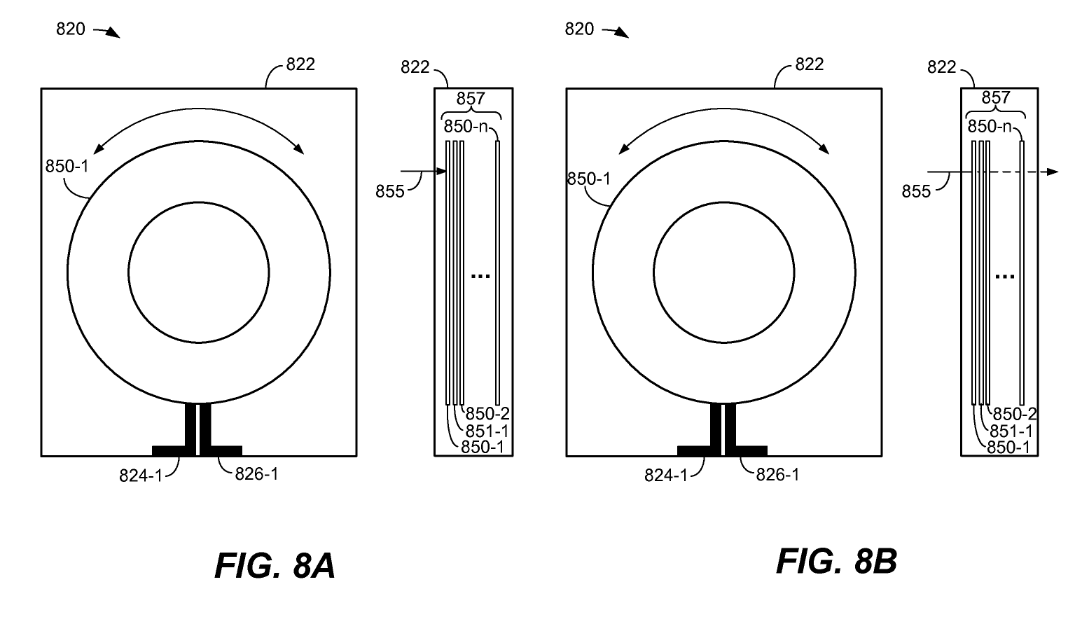

FIG. 8A shows an alternative exemplary embodiment of the optical attenuator of FIG. 2 in a first configuration. The embodiment shown in FIG. 8A is referred to as a “polarizing” type attenuator in that it uses optical polarization to completely or partially interrupt the optical signal. An optical attenuator 820 comprises a body 822. In an exemplary embodiment, the body 822 comprises a polarization element 857 that can be fabricated using a number of rotating elements, comprising waveplates 850-1 through 850-n and polarization gratings, 851-1 through 851-n. The number of waveplates 850-1 through 850-n and the number of polarization gratings 851-1 through 851-n can vary. Each waveplate 850-1 through 850-n and each polarization grating 851-1 through 851-n has corresponding electrical contacts 824-1 through 824-n and electrical contacts 826-1 through 826-n to allow independent control of the movement of each waveplate 850-1 through 850-n and each polarization grating 851-1 through 851-n.

In an exemplary embodiment, the polarization element 857 may comprise a first waveplate 850-1 and a first polarization grating 851-1. In this example, the first waveplate 850-1 and a first polarization grating 851-1 can be configured to selectively attenuate an optical signal traversing the body 822 from left to right, which would be from the connector 121 toward the connector 122 in the system of FIG. 1.

In another exemplary embodiment, the polarization element 857 may comprise a first waveplate 850-1, a first polarization grating 851-1 and a second waveplate 850-2. In this example, the first waveplate 850-1, the first polarization grating 851-1 and the second waveplate 850-2 can be configured to selectively attenuate optical signals traversing the body 822 from left to right (from the connector 121 toward the connector 122 in the system of FIG. 1) and/or from right to left (from the connector 122 toward the connector 121 in the system of FIG. 1.

In an exemplary embodiment, the first waveplate 850-1 may linearly polarize incident light from the connector 121 (FIG. 1). A second rotating element may comprise the polarization grating 851-1 configured to pass only light polarized along the axis of the grating, referred to hereafter as the primary axis of the polarization grating. The third rotating element may comprise the second waveplate 850-2 configured to linearly polarize incident light from the connector 122 (FIG. 1) in an exemplary embodiment where independent optical signal attenuation may occur in two directions. Additional rotating elements can be added to the “stack” to further affect signal polarization and attenuation.

In an exemplary embodiment, the relative angular positions of the waveplates 850-1 through 850-n and the polarization gratings 851-1 through 851-n can be adjusted so as to attenuate the optical signal 855 over a range of attenuation values. The rotating elements may be configured to completely or partially attenuate the optical signal.

In an exemplary embodiment using a polarization element 857 having a first waveplate 850-1, a first polarization grating 851-1 and a second waveplate 850-2, assume that the primary axis of the polarization grating 851-1 is 0 degrees. Each of the first waveplate 850-1, first polarization grating 851-1 and second waveplate 850-2 can be rotated independently of the other two to adjust and control the relative angles of the waveplates 850-1 and 850-2 and the first polarization grating 851-1.

As with other embodiments disclosed above, the polarization gratings and waveplates could also provide different attenuation values for signals propagating in different directions. For example, the polarization gratings and waveplates could be used to provide independent attenuation levels to optical signals traveling in different directions (e.g., from the connector 121 toward the connector 122 and from the connector 122 toward the connector 121, FIG. 1). As an exemplary embodiment, while passing the signal from the left (i.e., connector 121 of FIG. 1), a signal coming from the right (i.e., connector 122 of FIG. 1) can be blocked at the same time by adjusting the angular position of the second waveplate 850-2 relative to the polarization grating 851-1 such that the signal's polarization as it exits the second waveplate 850-2 is orthogonal to (i.e., is at a 90 degree rotational angle) the primary axis of the polarization grating 851-1.

Partial attenuation of either or both of the optical signals can be obtained by adjusting the angular position of the respective waveplates 850-1 and 850-2 more than 0 degrees but less than 90 degrees relative to the primary axis of the polarization grating 851-1 (defined in this example to be 0 degrees).

For the three layer exemplary embodiment above, the polarization grating 851-1 could be fixed and only the angular position of the waveplates 850-1 and 850-2 adjusted so that the polarization effect and attenuation effect would be the same as described above. However, if more layers (such as more diffraction gratings to facilitate more attenuation) are added, rotation control and relative angular position adjustment of all rotating elements can be implemented to optimize performance.

In an exemplary embodiment, the polarization element 857 may be implemented using micro-electromechanical system (MEMS) technology.

In this exemplary embodiment, the waveplates 850-1 through 850-n and the polarization gratings 851-1 through 851-n can be fabricated to attenuate an optical signal over a range of optical attenuation values, from near zero optical attenuation to complete optical attenuation. When oriented as shown in FIG. 8A, the rotating elements are configured such that an optical signal 855 entering the body 822 is substantially or completely attenuated.

FIG. 8B shows an alternative exemplary embodiment of the optical attenuator of FIG. 8A in a second configuration. When oriented as shown in FIG. 8B, the rotating elements are configured such that an optical signal 855 entering the body 822 is partially attenuated, or not attenuated, and traverses the optical attenuator 820. The relative angular positions of the rotating elements can be controlled by control signals applied through the electrical contacts 824-1 through 824-n and 826-1 through 826-n to independently effect the movement of the rotating elements through a variety of positions resulting in different attenuation values. In an exemplary embodiment, each waveplate 850-1 through 850-n, and each polarization grating 851-1 through 851-n can be independently controlled by a control signal through separate electrical contacts.

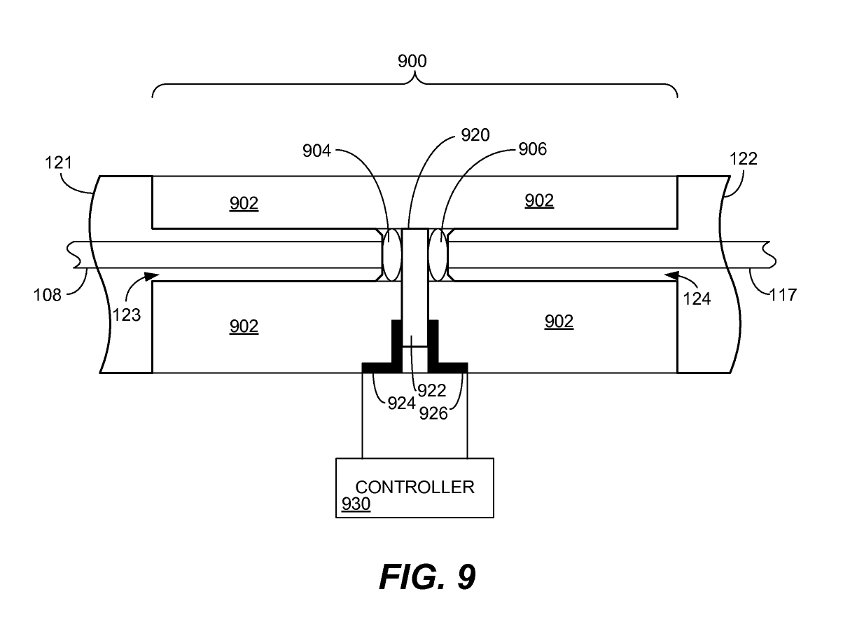

FIG. 9 shows an alternative exemplary embodiment of the optical fiber adapter with embedded optical attenuator of FIG. 2. The optical fiber adapter 900 comprises a body 902 into which connectors 121 and 122 may be releasably mated. In an example, the connector 121 includes a ferrule 123 that properly supports and aligns the optical fiber segment 108 within the body 902. The other components of the connector 121 are not shown for simplicity of illustration. Similarly, the connector 122 includes a ferrule 124 that properly supports and aligns the optical fiber segment 117 within the body 902. The other components of the connector 122 are not shown for simplicity of illustration.

The optical fiber adapter 900 also comprises an optical attenuator 920. The optical attenuator 920 comprises a body 922 and electrical contacts 924 and 926. The optical fiber adapter 900 also comprises optional lenses 904 and 906, which in some exemplary embodiments, aid in the coupling of optical signals between the optical fiber segment 108 and the optical fiber segment 117 through the optical attenuator 920.

The optical attenuator 920 can be similar to the optical attenuator 220 described above. In an exemplary embodiment, the body 922 of the optical attenuator 920 comprises optical attenuation means that can partially or completely attenuate the optical signal passing between the optical fiber segment 108 and the optical fiber segment 117 in response to a control signal provided through the electrical contacts 924 and 926. The control signal may be provided by a controller 930. The controller 930 can be similar to the controller 230 described above.

In an exemplary embodiment, the attenuator 920 can comprise any of the embodiments of the optical attenuator 220, 320, 420, 520, 620, 720 and 820 described herein.

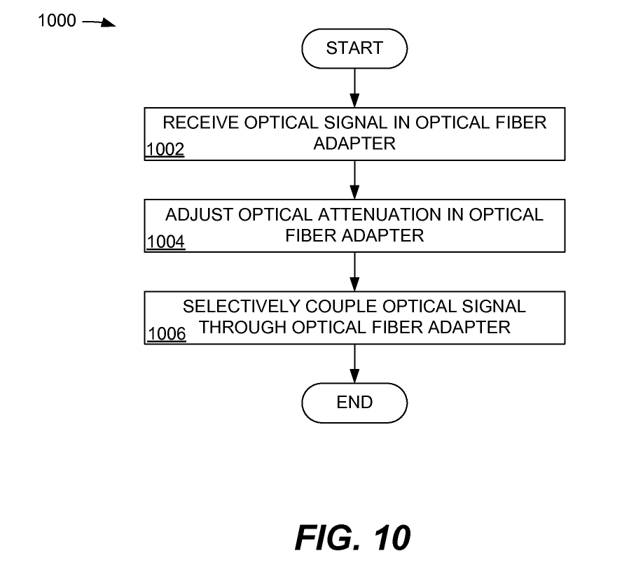

FIG. 10 is a flow chart describing an exemplary embodiment of a method for optical attenuation. The steps in the flow chart 1000 can be performed in or out of the order shown, and in some instances, may be performed in parallel.

In block 1002, an optical signal is received in an optical fiber adapter having an optical attenuator.

In block 1004, the optical attenuation of the optical signal is adjusted in the optical fiber adapter.

In block 1006, the optical signal is selectively coupled through the optical fiber adapter to another optical fiber. The amount of attenuation provided by the optical attenuator determines the selective coupling of the optical signal through the optical fiber adapter and can range zero optical attenuation to complete optical attenuation.

While exemplary embodiments of an optical fiber adapter with embedded optical attenuator have been described, those having ordinary skill in the art will recognize that other commonly known and used elements, components and structures, such as for example only, index matching material, and other optical and/or electrical elements, have been excluded from the figures and discussion for clarity purposes since those elements do not contribute to the novelty of the exemplary embodiments of the optical fiber adapter with embedded optical attenuator described herein.

While various embodiments of the invention have been described, it will be apparent to those of ordinary skill in the art that many more embodiments and implementations are possible that are within the scope of this invention.

What is claimed is:

1. A device, comprising:
an optical fiber adapter configured to releasably connect a first optical fiber and a second optical fiber, the optical fiber adapter configured to lenselessly couple an optical signal from the first optical fiber to the second optical fiber; and
an optical attenuator embedded in the optical fiber adapter, the optical attenuator configured to variably attenuate the optical signal responsive to a control signal.

2. The device of claim 1, wherein the optical attenuator comprises a micro-electromechanical system (MEMS) device.

3. The device of claim 2, wherein the MEMS device comprises a movable shutter.

4. The device of claim 2, wherein the MEMS device comprises a rotating element comprising a plurality of optical filters.

5. The device of claim 4, wherein the rotating element comprising a plurality of optical filters provides a range of optical attenuation values, from zero optical attenuation to complete optical attenuation.

6. The device of claim 1, wherein the optical attenuator comprises an electro-chromic or an electro-optic element.

7. The device of claim 6, wherein the electro-chromic element or the electro-optic is configured to provide a range of optical attenuation values, from zero optical attenuation to complete optical attenuation.

8. The device of claim 3, wherein the movable shutter can be fabricated of a material that provides attenuation ranging from zero optical attenuation to complete optical attenuation.

9. The device of claim 8, wherein the movable shutter provides spectral filtering properties.

10. The device of claim 5, wherein at least one of the plurality of optical filters provides spectral filtering properties.

11. The device of claim 1, wherein the optical attenuator comprises a diffractive element.

12. The device of claim 11, wherein the diffractive element comprises a diffraction grating.

13. The device of claim 1, wherein the optical attenuator comprises a refractive element.

14. The device of claim 1, wherein the optical attenuator comprises an optical polarizing element.

15. The device of claim 14, wherein the optical polarizing element comprises a micro-electromechanical system (MEMS) device, the MEMS device comprising a plurality of rotating elements affecting the polarization and attenuation of an incident optical signal.

16. The device of claim 15, wherein adjusting the relative angular position of the plurality of rotating elements affects the polarization and attenuation of the incident optical signal.

17. A method for optical attenuation, comprising:
receiving an optical signal in an optical fiber adapter configured to releasably connect a first optical fiber and a second optical fiber, the optical fiber adapter configured to lenselessly couple an optical signal from the first optical fiber to the second optical fiber, the optical fiber adapter having an optical attenuator
adjusting an optical attenuation of the optical attenuator; and
selectively coupling the optical signal through the optical fiber adapter.

18. The method of claim 17, wherein selectively coupling the optical signal through the optical fiber adapter comprises completely preventing the optical signal from passing through the optical fiber adapter.

19. The method of claim 17, wherein selectively coupling the optical signal through the optical fiber adapter comprises partially preventing the optical signal from passing through the optical fiber adapter.

20. The method of claim 17, wherein selectively coupling the optical signal through the optical fiber adapter comprises allowing the optical signal to pass through the optical fiber adapter but preventing the optical signal from coupling to an optical fiber.
